(19) United States
(12) Patent Application Publication
(10) Pub. No.: US 2014/0002584 A1
(43) Pub. Date: Jan. 2, 2014

(54) METHOD OF SELECTING CONFERENCE PROCESSING DEVICE AND VIDEO CONFERENCE SYSTEM USING THE METHOD

(71) Applicant: ELECTRONICS AND TELECOMMUNICATIONS RESEARCH INSTITUTE, Daejeon (KR)

(72) Inventors: Seong MOON, Daejeon (KR); Ho Yong RYU, Daejeon (KR); Ho Sun YOON, Daejeon (KR); Sun Cheul KIM, Daejeon (KR); Seungwoo HONG, Daejeon (KR); Sung Back HONG, Daejeon (KR); Jung Sik KIM, Daejeon (KR); Sangjin HONG, Gyeonggi-do (KR); Pyung-Koo PARK, Daejeon (KR); Young Soo SHIN, Daejeon (KR)

(73) Assignee: Electronics and Telecommunications Research Institute, Daejeon (KR)

(21) Appl. No.: 13/733,496

(22) Filed: Jan. 3, 2013

(30) Foreign Application Priority Data
Jun. 27, 2012 (KR) 10-2012-0069450

(51) Int. Cl. H04N 7/15

(52) U.S. Cl. 348/14.08

(57) ABSTRACT

In order to select a conference processing device to host a video conference between conference participation devices, a video conference system selects conference processing devices that are positioned most adjacent to each of conference participation devices that participate in the video conference as candidates for a conference processing device. The video conference system forms network topology based on candidate conference processing devices and conference participation devices, and aligns candidate conference processing devices based on preset alignment reference information. The video conference system selects one of the aligned candidate conference processing devices as an optimal conference processing device to host the video conference.

### CROSS-REFERENCE TO RELATED APPLICATION

This application claims priority to and the benefit of Korean Patent Application No. 10-2012-0069450 filed in the Korean Intellectual Property Office on Jun. 27, 2012, the entire contents of which are incorporated herein by reference.

### BACKGROUND OF THE INVENTION

(a) Field of the Invention

The present invention relates to a video conference system. More particularly, the present invention relates to a method of selecting a conference processing device in a video conference system and a video conference system using the method.

(b) Description of the Related Art

Nowadays, as a bandwidth of a network increases and processing performance of user devices improves, a demand for video conferencing is remarkably increasing. Because a video conference is basically performed in a form that carries multimedia image and audio data, an increase in video conferencing causes a traffic increase of a network.

Video conference services are divided into a centralized type of structure and a dispersion of type structure. In a video conference service of a centralized type of structure, conference participants use a service through a multipoint control unit (MCU) that is constructed as a closed type at the center. In this case, the MCU collects and processes data that is generated in each video conference participation site, again transfers the data to each video conference participation site, and performs a procedure such as call control, media channel control, and authentication with the video conference device and processing of actual multimedia data. Because the procedure such as call control, media channel control, and authentication is processed with a relatively simple signaling method, the procedure does not cause a traffic load to a network, but because image and audio traffic for an actual video conference occupies a large bandwidth, the image and audio traffic causes much traffic to the network. In this way, in an environment that provides a video conference service using a centralized type of MCU, a phenomenon that increases a traffic load of the network becomes an unavoidable defect.

The dispersion type of video conference structure geographically disposes MCUs at several locations, selects an MCU to host a conference among dispersion type MCUs, and notifies a video conference participation site of the selected MCU. Thereafter, the video conference participation site sets a channel to the selected MCU and transmits/receives multimedia data through a corresponding channel, thereby performing a video conference.

In such a dispersion type of video conference structure, when an MCP is selected, in order to minimize quality deterioration in a network that a user generally feels, the MCU is selected based on network information, i.e., network delay from each conference participation site to the MCU, network bandwidth, and geographical position information. An order of MCUs is provided based on this information, and MCUs having a highest communication quality have selection priority.

As described above, a method of selecting an MCU using network information only for quality of a video conference which a user feels does not perform a function of dispersing traffic in an entire network. That is, conventionally, an MCU is selected as a method of enabling video conference service users to not feel a delay of a network and quality deterioration of a jitter rather than dispersing traffic of a network and thus traffic is not dispersed, whereby traffic of a network increases. As a result, it is difficult to control an entire network, and an unnecessary network increase and a large amount of traffic is caused.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method of selecting an optimal conference processing device that can disperse network traffic in a dispersion type of video conference environment, and a video conference system using the method.

An exemplary embodiment of the present invention provides a method in which a video conference system selects a conference processing device that hosts a video conference between conference participation devices, the method including: receiving, by the video conference system, a conference opening request message from the conference participation device and selecting conference processing devices that are positioned most adjacent to each of conference participation devices that participate in a video conference as a conference participation device; forming, by the video conference system, network topology based on the candidate conference processing devices and the conference participation devices; aligning, by the video conference system, the candidate conference processing devices based on alignment reference information; and selecting, by the video conference system, one conference processing device of the aligned candidate conference processing devices as an optimal conference processing device to host the video conference.

The alignment reference information may include at least one of a hop number between nodes that form the network topology, a round trip time (RTT) between nodes, and a link speed between nodes.

The selecting of one conference processing device may include: calculating each of hop numbers necessary for hosting each of the conference participation devices on a candidate conference processing device basis, which is a node that forms the network topology; calculating a final hop number by adding hop numbers that are calculated on a candidate conference processing device basis; and selecting a candidate conference processing device having a minimum hop number based on the final hop number on the candidate conference processing device basis as an optimal conference processing device.

The conference opening request message may include codec information about image/audio data that is requested by the conference processing device. The selecting of one conference processing device may include: selecting one of candidate conference processing devices that are aligned based on the alignment reference information; and selecting, when the selected candidate conference processing device has a codec corresponding to codec information that is included in the conference opening request message, the selected conference processing device as an optimal conference processing device.

The selecting of one conference processing device may further include selecting, when the selected candidate conference processing device secures a resource for processing of multimedia traffic, the selected candidate conference processing device as an optimal conference processing device.

The method may further include notifying conference participation devices that participate in the video conference of the selected optimal conference processing device.

Another embodiment of the present invention provides a video conference system that controls a conference participation device and a conference processing device to perform a video conference, the video conference system including: a manager controller that selects conference processing devices that are positioned most adjacent to each of conference participation devices that participate in a video conference as a candidate conference processing device, that aligns the conference participation devices based on alignment reference information, and that selects one of the aligned conference participation devices as an optimal conference processing device to host the video conference; a call controller that sets up a call between conference participation devices and that sets up a media channel; and a media channel controller that optimizes the media channel and that manages a resource.

The manager controller may include: a selection module that selects conference processing devices that are positioned most adjacent to conference participation devices that participate in a video conference as a candidate conference processing device; a forming module that forms network topology based on conference participation devices and the candidate conference processing devices that participate in the video conference; an alignment module that aligns candidate conference processing devices of the network topology based on alignment reference information; and a final selection module that selects one of the aligned candidate processing devices as an optimal conference processing device to host the video conference.

The manager controller may select a candidate conference processing device having a minimum hop number as an optimal conference processing device based on the hop number between the nodes.

The manager controller may select the selected candidate conference processing device as an optimal conference processing device when the selected candidate conference processing device has a codec that is requested by the video conference and secures a resource for processing of multimedia traffic.

### BRIEF DESCRIPTION OF THE DRAWINGS

FIG. 1 is a diagram illustrating a network environment for a video conference according to an exemplary embodiment of the present invention.

FIG. 2 is a diagram illustrating a configuration of a conference participation device according to an exemplary embodiment of the present invention.

FIG. 3 is a block diagram illustrating a configuration of a multipoint controller according to an exemplary embodiment of the present invention.

FIG. 4 is a block diagram illustrating a configuration of a manager controller of a multipoint controller according to an exemplary embodiment of the present invention.

FIG. 5 is a block diagram illustrating a configuration of a conference processing device according to an exemplary embodiment of the present invention.

FIG. 6 is a flowchart illustrating a method of selecting a conference processing device according to an exemplary embodiment of the present invention.

FIG. 7 is a diagram illustrating a node aligning process according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising” will be understood to imply the inclusion of stated elements but not the exclusion of any other elements.

Hereinafter, a method of selecting a conference processing device and a video conference system using the method according to an exemplary embodiment of the present invention will be described with reference to the drawings.

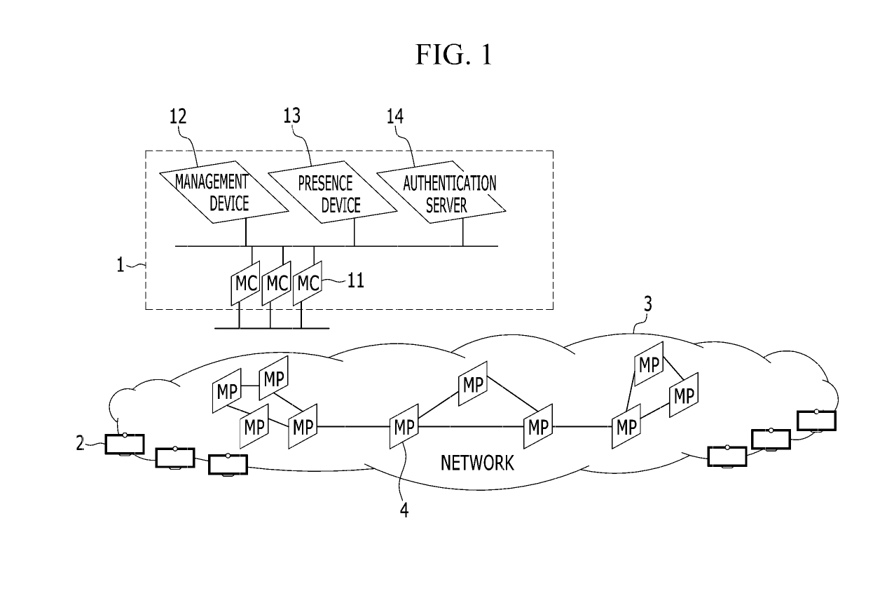

FIG. 1 is a diagram illustrating a network environment for a video conference according to an exemplary embodiment of the present invention.

As shown in FIG. 1, a video conference system 1 transmits and receives data from and to a plurality of conference participation sites, i.e., conference participation devices 2, and the conference participation devices 2 are connected to each other through a network 3 such as public Internet or an exclusive network. A plurality of conference processing devices, i.e., multipoint processors (MP) 4, are dispersed on the network 3 to perform processing of multimedia data between the video conference system 1 and the conference participation device 2.

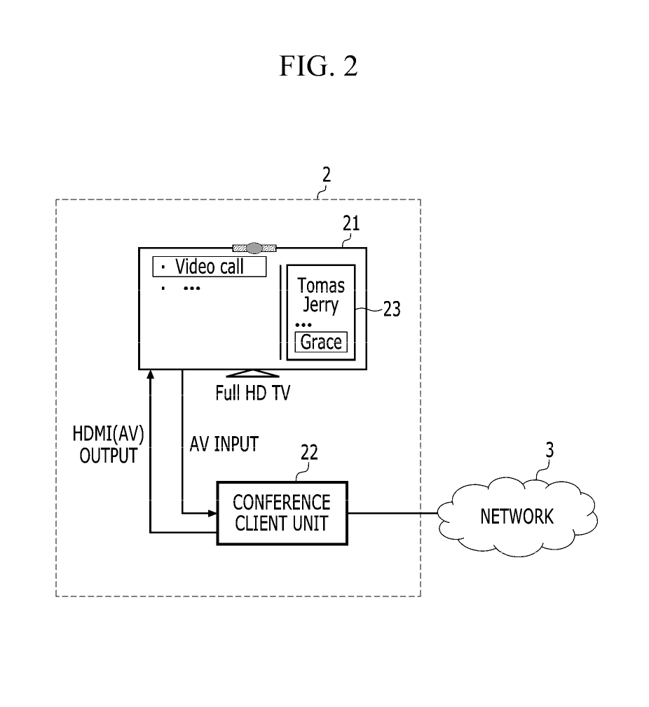

FIG. 2 is a diagram illustrating a configuration of a conference participation device according to an exemplary embodiment of the present invention.

As shown in FIG. 2, the conference participation device 2 according to an exemplary embodiment of the present invention includes a data input/output unit 21 for input/output of data such as image/audio, a conference client unit 22 that processes data that is provided from the data input/output unit 21, transmits the data to the conference procession device 4 on the network 3, processes received data, transfers the data to the data input/output unit 21, and enables output of the data, and a user interface unit 23.

The data input/output unit 21 includes an input device (e.g., a camera and a microphone) that inputs image data and audio data and an output device (e.g., a television) that outputs image data and audio data.

The conference client unit 22 performs multimedia data encoding/decoding that encodes data that is provided from the data input/output unit 21, transmits the encoded data to the conference processing device 4, decodes data that is received from the conference processing device 4, and transfers the decoded data to the data input/output unit 21. Further, the conference client unit 22 performs call control for data transmission/reception and performs media channel control or user interface (UI) control for data input/output. The conference client unit 22 is connected to a public network or an exclusive network through a wired network or a wireless network, and may be embodied in various forms.

The user interface unit 23 provides data according to a user selection to the conference client unit 22. The user interface unit 23 may be in a form that is embodied on a display screen of the data input/output unit 21, or may be embodied as a separate device from the data input/output unit 21.

As shown in FIG. 1, the video conference system 1 according to an exemplary embodiment of the present invention includes a multipoint controller (MC) 11, a management device 12, a presence device 13, and an authentication server 14.

The video conference system 1 performs a function of a control brain in a video conference service, and performs major functions of conference opening, conference participation, presence information determination, and user or device authentication that are requested by the conference participation device 2.

The management device 12 performs reservation and management of a conference, and the presence device 13 manages presence information of each participant, i.e., the conference participation device 2. The authentication server 14 performs authentication of the conference participation device 2 or conference participants.

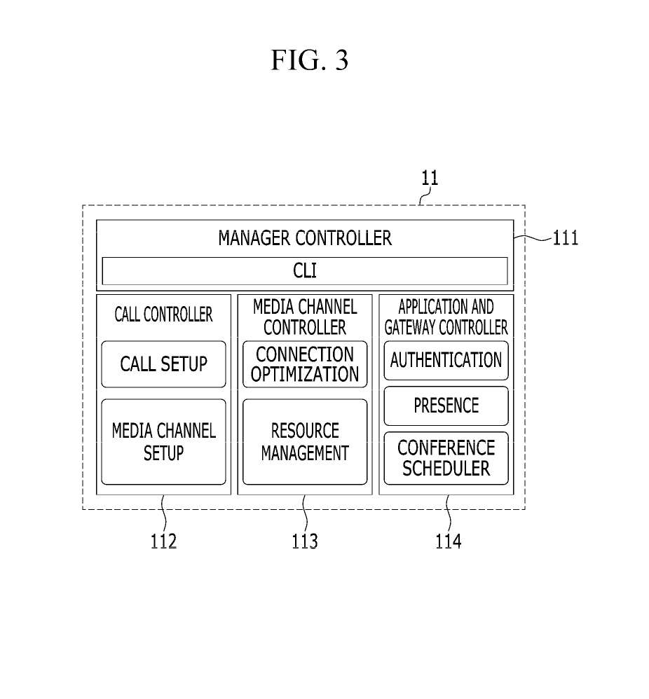

The MC 11 performs entire management for a video conference service and selects, particularly, an optimal conference processing device 4. For this purpose, the MC 11 has a configuration of FIG. 3.

Here, a plurality of MCs 11 may be used, and thus when a load is dispersed or when service of a node has failed, a service may be transferred to another node.

FIG. 3 is a block diagram illustrating a configuration of an MC according to an exemplary embodiment of the present invention.

As shown in FIG. 3, the MC 11 according to an exemplary embodiment of the present invention includes a manager controller 111, a call controller 112, a media channel controller 113, and an application and gateway controller 114.

The manager controller 111 selects a manager that performs a conference and controls the selected manager, thereby enabling to perform a conference. This will be described in detail later.

The call controller 112 sets up a call between the conference participation devices 2 and performs call control and media channel control that set up a media channel.

The media channel controller 113 performs a function of optimizing a media channel and managing a resource.

The application and gateway controller 114 controls authentication of the conference participation devices 2 by connecting to the authentication server 14, and performs an interface function of acquiring presence information about conference participation devices by connecting to the presence device 13 and providing the presence information to the presence device 13. Further, the application and gateway controller 114 performs a function as a scheduler that schedules each conference.

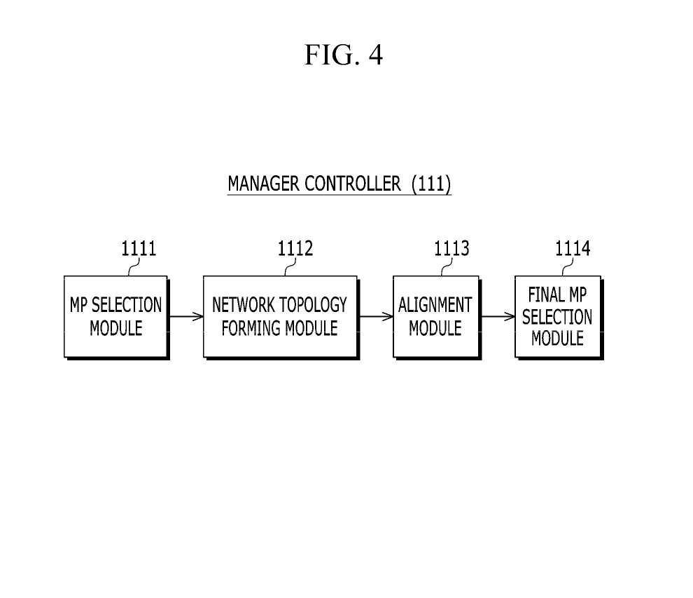

The manager controller 111 has a configuration of FIG. 4.

FIG. 4 is a block diagram illustrating a configuration of a manager controller of an MC according to an exemplary embodiment of the present invention.

As shown in FIG. 4, the manager controller 111 includes an MP selection module 1111, a network topology forming module 1112, an alignment module 1113, and a final MP selection module 1114.

The MP selection module 1111 selects MPs that are positioned most adjacent to conference participation devices that participate in a conference. The network topology forming module 1112 forms network topology based on conference participation devices that participate in a conference and selected MPs.

The alignment module 1113 aligns nodes that form network topology and aligns nodes, i.e., based on MPs, and particularly, alignment reference information according to an exemplary embodiment of the present invention. Here, the alignment reference information includes at least one of the hop number between nodes, round trip time (RTT) between nodes, and link speed between nodes.

The final MP selection module 1114 aligns MPs, which are nodes that form network topology, based on alignment reference information, and selects an MP to host a video conference among aligned MPs.

In a video conference, a conference processing device, i.e., an MP 4 that performs collection and processing of actual multimedia data, has the following configuration.

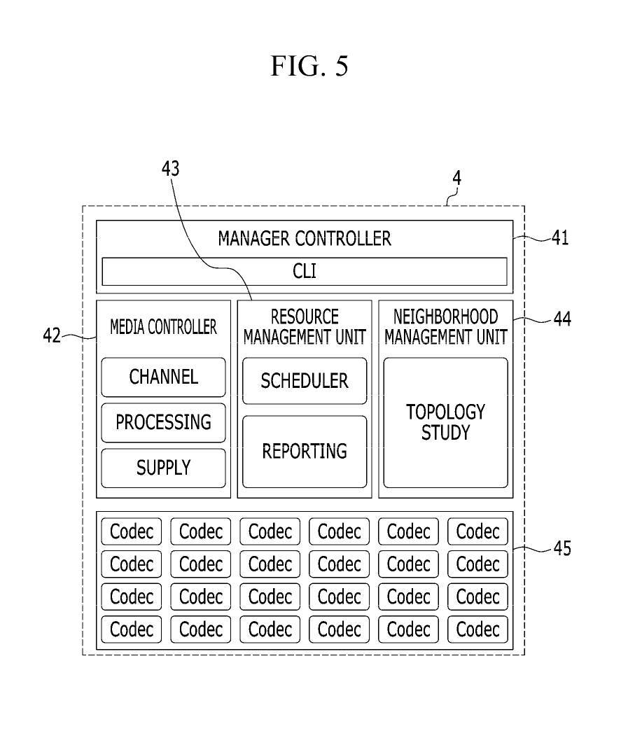

FIG. 5 is a block diagram illustrating a configuration of a conference processing device according to an exemplary embodiment of the present invention.

The MP 4 according to an exemplary embodiment of the present invention collects image/audio data that is generated in a video conference, and processes and transmits the collected data. For this purpose, as shown in FIG. 5, the MP 4 includes a manager controller 41, a media controller 42, a resource management unit 43, a neighborhood management unit 44, and a plurality of codecs 45.

The media controller 42 collects image/audio data that is generated in a video conference by performing media channel control and media processing control, and processes data based on the codec 45 that is allocated by the resource management unit 43. The manager controller 42 provides the processed data to related devices.

The resource management unit 43 performs scheduling of codec resources and reports a current resource condition. The neighborhood management unit 44 studies topology of adjacent MPs.

Hereinafter, a method of selecting a conference processing device according to an exemplary embodiment of the present invention will be described.

The MPs 4 are installed to connect to the conference client unit 22 that is included in each conference participation device through a network such as a public network or an exclusive network, and when the MPs 4 are installed, positions of the MPs 4 may be previously known. For example, positions of the MPs 4 may be preset by an installation engineer or a user, or by mounting a global positioning system module (GPS) to the MP 4, and a position of each MP 4 may be identified through the GPS module. Alternatively, when an official IP is used, an MP position may be identified based on an IP address that is given to each MP 4. Alternatively, positions of the MPs 4 may be determined through a process of transmitting an inquiry message to the MPs 4 and receiving a response message to the inquiry message. In this case, for example, the MC 11 may determine most adjacent MPs on a network through a process of transmitting an inquiry message to MPs that are included in the list based on a list of MPs of the same area, and receiving a response message to the inquiry message. In this way, by securing position information about MPs 4 through various methods, the MC 11 can know an MP most adjacent to each conference participation device.

The video conference service may start opening a conference when a conference participation site, i.e., the conference participation device 2 receives user input, or may start opening a conference that is reserved by a video conference portal site, i.e., the video conference system 1.

A case where the conference participation device 2 starts a conference opening will be exemplified.

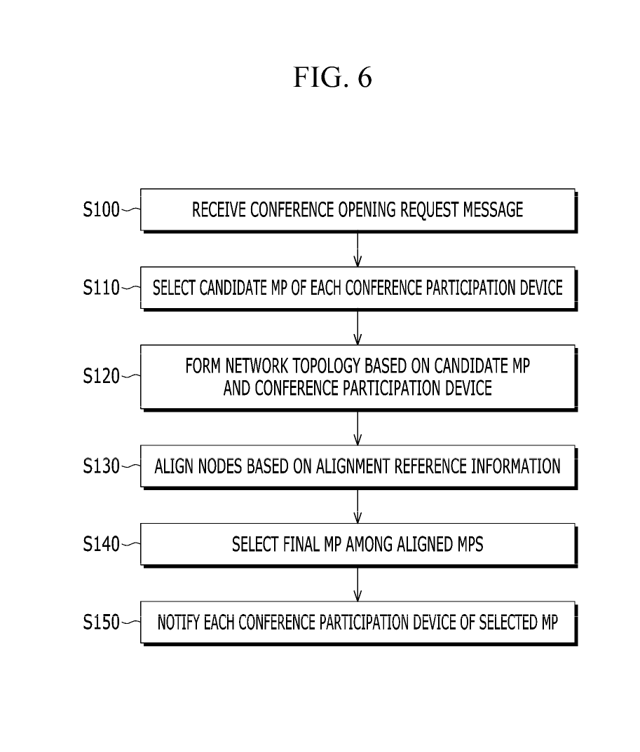

FIG. 6 is a flowchart illustrating a method of selecting a conference processing device according to an exemplary embodiment of the present invention.

As shown in FIG. 6, the conference client unit 22 of the conference participation device 2 receives input of information of a participant to participate in a conference from a user, and requests a conference opening to the MC 11. The MC 11 performs authentication of the user or the conference participation device 2 through the authentication server 14, as needed. When requesting an opening of a video conference, while transferring a conference opening request message including ID or an address of another conference participation site, i.e., another conference participation device that wants to participate in the conference, and codec information about image/audio data in which the conference client unit 22 wants to the MC 11, the conference client unit 22 requests a conference opening.

When the conference opening request message is received from the conference client unit 22 of a plurality of conference participation devices 2 (S100), in order to perform scheduling of a video conference, the MC 11 selects an MP to perform processing of transmitted/received media data upon performing a video conference and notifies the conference client unit 22 of the conference participation device 2 of the selected MP.

In order to select an MP to host a video conference, the MC 11 first selects candidate MPs (S110). For this purpose, the MC 11 selects MPs most adjacent to each conference participation device as candidate MPs. As described above, because position information about each MP may be known through various methods, the MC 11 can easily select each of MPs most adjacent to each conference participation device based on position information of previously secured MPs.

Next, the MC 11 forms real-time network topology based on each conference participation device and the selected MPs of each conference participation device 2 (S120). That is, the MC 11 forms conference participation devices that request a conference and MPs that are positioned most adjacent to each conference participation devices as a node, and forms network topology including information about a connection state of nodes.

The MC 11 aligns MPs to minimize dispersion of network traffic based on the formed network topology. In this case, the MC 11 aligns nodes based on alignment reference information (S130). Here, the MC 11 aligns nodes based on the hop number between nodes. Alternatively, the MC 11 may align nodes based on the hop number between nodes and realign nodes by additionally considering a round trip time (RTT) between nodes and a link speed between nodes. The MC 11 may align nodes in consideration of only an RTT, or may align nodes in consideration of only a link speed.

The MC 11 selects an optimal MP to host a video conference of each conference participation device based on the aligned MPs (S140).

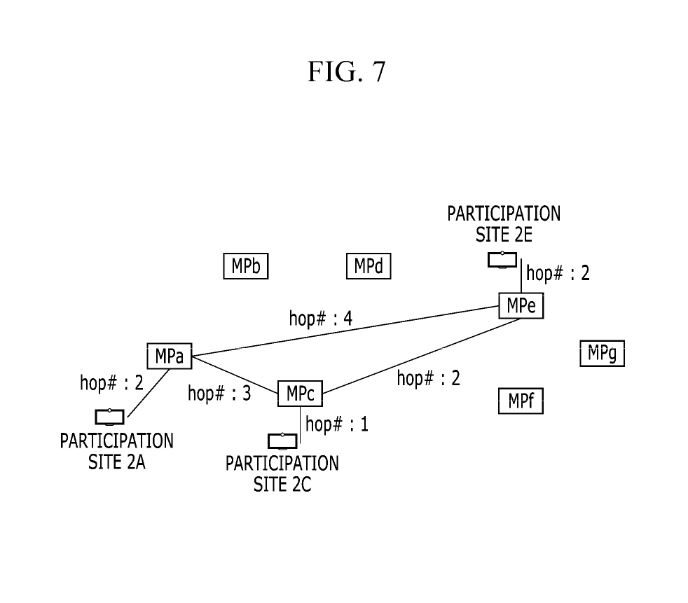

FIG. 7 is a diagram illustrating a node aligning process according to an exemplary embodiment of the present invention, and particularly, illustrates an example of selecting an optimal MP based on the hop number.

For example, as shown in FIG. 7, it is assumed that a plurality of MPs, i.e., MPa, MPb, MPc, MPd, MPe, MPf, and MPg exist in a network and 2A, 2C, and 2E exist as a conference participation site, i.e., a conference participation device. It is assumed that MPs most adjacent to the conference participation devices 2A, 2C, and 2E are MPa, MPc, and MPe, respectively. In this case, because the MPb, MPd, MPf, and MPg do not participate in a video conference for the conference participation devices 2A, 2C, and 2E, the MPb, MPd, MPf, and MPg are excluded from an entire network topology configuration.

Therefore, network topology of actual video conference devices 2A, 2C, and 2E and MPa, MPc, and MPe that are positioned most adjacent to each video conference device is formed. Table 1 represents an example of forming network topology based on the hop number of nodes constituting network topology.

TABLE 1

| | 2A | 2C | 2E | Hop number |
|---|---|---|---|---|
| MPa | 2 | 4 | 6 | 12 |
| MPc | 5 | 1 | 4 | 10 |
| MPe | 6 | 3 | 2 | 11 |

Referring to Table 1 and FIG. 7, in order for the MPa to host each of the conference participation devices 2A, 2C, and 2E, the hop numbers of 2, 4, and 6 is requested, and the final hop number 12, which is the sum of the hop numbers, is necessary. In order for the MPc to host each of the conference participation devices 2A, 2C, and 2E, the hop numbers of 5, 1, and 4 are requested, the final hop number 10, which is the sum of the hop numbers is necessary, and in order for the MPe to host each of the conference participation devices 2A, 2C, and 2E, the hop numbers of 6, 3, and 2 are requested, and the final hop number 11, which is the sum of the hop numbers is necessary.

In this way, network topology selects an MC to host the conference participation devices 2A, 2C, and 2E based on the hop number, and particularly, the MPc having the minimum hop number is selected as a hosting MP.

As described above, after MPs forming network topology are aligned based on the hop number MP, an MP having the minimum hop number may be selected as an optimal MP.

When an optimal MP of aligned MPs is selected, it may be additionally considered whether each MP has a codec to host a video conference and whether sufficient resources that can perform processing of multimedia traffic exist. For example, when an MPc having the minimum hop number is selected according to the above illustration, the MC 11 determines whether the selected MPc has a codec to host and has sufficient resources that can process multimedia traffic. If the selected MPc does not have a corresponding codec or does not have sufficient resources, the MC 11 selects another MP, i.e., MPe having the minimum hop number after the MPc as an optimal MP to host.

The MC 11 additionally considers an additional determination reference on whether each MP has a codec to host a video conference and has sufficient resources that can process multimedia traffic based on aligned MPs through such a process, thereby finally selecting an MP to host the video conference. In addition, the MC 11 selects an optimal MP by additionally considering a policy of a service provider as well as information about the network. When a policy that intentionally detours traffic to an MP of another area is used for avoiding a traffic overload of a specific area, by additionally considering a corresponding policy, an optimal MP may be selected.

Thereafter, the MC 11 notifies each conference participation device 2 of the finally selected MP (S150). Thereafter, the conference client unit 22 of the conference participation device 2 sets a media channel by communicating with the selected MP, and transmits/receives multimedia data through the set channel.

According to an exemplary embodiment of the present invention, when providing a video conference service, an optimal conference processing device to perform a media processing service of each video conference can be selected based on network topology information of all conference processing devices. Therefore, multimedia data due to a video conference causing an increase in network traffic can be minimized. Further, by recognizing network topology of all conference processing devices, a management policy of a video conference service provider can be dynamically and softly applied.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a video conference system selects a conference processing device that hosts a video conference between conference participation devices, the method comprising:
receiving, by the video conference system, a conference opening request message from the conference participation device and selecting conference processing devices that are positioned most adjacent to each of conference participation devices that participate in a video conference as a conference participation device;
forming, by the video conference system, network topology based on the candidate conference processing devices and the conference participation devices;
aligning, by the video conference system, the candidate conference processing devices based on alignment reference information; and
selecting, by the video conference system, one conference processing device of the aligned candidate conference processing devices as an optimal conference processing device to host the video conference.

2. The method of claim 1, wherein the alignment reference information comprises at least one of a hop number between nodes that form the network topology, a round trip time (RTT) between nodes, and a link speed between nodes.

3. The method of claim 2, wherein the selecting of one conference processing device comprises:
calculating each of hop numbers necessary for hosting each of the conference participation devices on a candidate conference processing device basis, which is a node that forms the network topology;
calculating a final hop number by adding hop numbers that are calculated on a candidate conference processing device basis; and
selecting a candidate conference processing device having a minimum hop number based on the final hop number on the candidate conference processing device basis as an optimal conference processing device.

4. The method of claim 1, wherein the conference opening request message comprises codec information about image/audio data that is requested by the conference processing device.

5. The method of claim 4, wherein the selecting of one conference processing device comprises:
selecting one of candidate conference processing devices that are aligned based on the alignment reference information; and
selecting, when the selected candidate conference processing device has a codec corresponding to codec information that is included in the conference opening request message, the selected conference processing device as an optimal conference processing device.

6. The method of claim 5, wherein the selecting of one conference processing device further comprises selecting, when the selected candidate conference processing device secures a resource for processing of multimedia traffic, the selected candidate conference processing device as an optimal conference processing device.

7. The method of claim 1, further comprising notifying conference participation devices that participate in the video conference of the selected optimal conference processing device.

8. A video conference system that controls a conference participation device and a conference processing device to perform a video conference, the video conference system comprising:
a manager controller that selects conference processing devices that are positioned most adjacent to each of conference participation devices that participate in a video conference as a candidate conference processing device, that aligns the conference participation devices based on alignment reference information, and that selects one of the aligned conference participation devices as an optimal conference processing device to host the video conference;
a call controller that sets up a call between conference participation devices and that sets up a media channel; and
a media channel controller that optimizes the media channel and that manages a resource.

9. The video conference system of claim 8, wherein the manager controller comprises:
a selection module that selects conference processing devices that are positioned most adjacent to conference participation devices that participate in a video conference as a candidate conference processing device;
a forming module that forms network topology based on conference participation devices and the candidate conference processing devices that participate in the video conference;
an alignment module that aligns candidate conference processing devices of the network topology based on alignment reference information; and
a final selection module that selects one of the aligned candidate processing devices as an optimal conference processing device to host the video conference.

10. The video conference system of claim 9, wherein the alignment reference information comprises at least one of a hop number between nodes that form the network topology, an RTT between nodes, and a link speed between nodes.

11. The video conference system of claim 10, wherein the manager controller selects a candidate conference processing device having a minimum hop number as an optimal conference processing device based on the hop number between the nodes.

12. The video conference system of claim 10, wherein the manager controller selects the selected candidate conference processing device as an optimal conference processing device when the selected candidate conference processing device has a codec that is requested by the video conference and secures a resource for processing of multimedia traffic.
